(19) United States
(12) Patent Application Publication
(10) Pub. No.: US 2008/0147919 A1
(43) Pub. Date: Jun. 19, 2008

(54) Semiconductor memory device

(75) Inventor: Hun-Sam Jung, Kyoungki-do (KR)

Correspondence Address: MCDERMOTT WILL & EMERY LLP, 600 13TH STREET, N.W., WASHINGTON, DC, 20005-3096, US

(73) Assignee: HYNIX SEMICONDUCTOR INC.

(21) Appl. No.: 11/647,145

(22) Filed: Dec. 29, 2006

(30) Foreign Application Priority Data
Jul. 20, 2006 (KR) 2006-0068124

(51) Int. Cl. G06F 3/00

(52) U.S. Cl. 710/56

(57) ABSTRACT

A semiconductor memory device is capable of reducing a leakage current applied to data input circuits and preventing malfunction during a test condition. The device includes a first data input circuit for receiving a first data signal, a second data input circuit for receiving a second data signal and providing the second data signal as an internal data signal, is the second data signal disabled in response to a test mode signal, and an input controller for controlling input timing of data signals being input to the first and the second data input circuits.

### CROSS-REFERENCE TO RELATED APPLICATION

The present invention claims priority of Korean patent application number 10-2006-0068124, filed on Jul. 20, 2006, which is incorporated by reference in its entirety.

### BACKGROUND OF THE INVENTION

The present invention relates to a semiconductor memory device; and, more particularly, to a data input circuit for use in the semiconductor memory device.

As well-known in the art, a semiconductor memory device is a semiconductor device that stores lots of data and provides the stored data. This semiconductor memory device includes a data storage area storing data and an input/output area in which a circuit for outputting the data stored in the data storage area or delivering input data thereto is disposed. The input/output area comprises a data input circuit for conveying external data to the data storage area, a data output circuit for externally outputting data from the data storage area, a control circuit for controlling the data input circuit and the data output circuit, and an address input circuit for receiving an external address and forwarding it to the data storage area.

More specifically, the data input circuit adjusts an external data signal via an input/output pad to a signal magnitude for application to the data storage area. In general, the semiconductor memory device receives or outputs plural data during a single data access operation, and comprises data input circuits corresponding to the number of data received or output. For example, if 16 data bits are received during a single data access, 16 data input circuits are provided. The number of data bits received or output during the single data access is set to any one of 4, 8, and 16. Upon manufacture of the semiconductor memory device, the number of data to be received or output can be set to one of 4, 16, or 32 bits.

FIG. 1 is a circuit diagram of a conventional data input circuit.

Referring to FIG. 1, the data input circuit includes MOS transistors MN1, MN2, MP1 and MP2, and inverters I1 and I2. In this structure, the inverter I2 inverters an enable signal EN and outputs an inverted enable signal EN. The MOS transistor MP1 receives a data signal DIN via a gate is supplied at one terminal by a driving voltage supply end VPERI_I for peripheral areas. The MOS transistor MP2 receives an output of the inverter I2 via a gate, and is connected at one terminal to the driving voltage supply end VPERI_I. The MOS transistor MN1 receives the output of the inverter I2 via a gate, and is commonly coupled to the other terminals of the MOS transistors MP1 and MP2. The MOS transistor MN2 receives the data signal DIN via a gate, and is connected at one terminal to the other terminal of the MOS transistor MN1, the other terminal thereof connected to a ground voltage supply end VSSI. The inverter I1 inverts a signal applied to the common other terminals of the MOS transistors MP1 and MP2 to output an internal data signal DIN_BUF.

FIG. 2 is a circuit diagram of the enable signal used in the data input circuit shown in FIG. 1.

Referring to FIG. 2, the circuit for generating the enable signal EN is configured to receive control signals OE_CKE and CKEB_RAS and generate the enable signal EN.

FIG. 3 is a waveform diagram describing the operation of the data input circuit depicted in FIG. 1.

As shown therein, when the enable signal EN is in a disable state by high level, the data input circuit does not transfer data. When the enable signal EN is in an enable state by low level, the data input circuit outputs an input signal DIN of high level or low level H/L as an internal data signal DIN_BUF. If a node in which the data signal DIN is input becomes high impedance since the data signal is not input while the enable signal EN is in high level state, the gates of the MOS transistors MP1 and MN2 are in a floating state. Due to this, a current continues to flow between the driving voltage supply end VPERI_I and the ground voltage supply end VSSI.

FIG. 4 is a block diagram of a data input unit used in the semiconductor memory device.

With reference to FIG. 4, the data input unit includes data input circuits corresponding in number to the number of input data signals. Here, it is assumed that 32 data signals are input during a single data access operation. Each data input circuit has the same circuit and configuration as shown in FIG. 1. An enable signal EN used therein may be generated by the circuit as shown in FIG. 2.

FIG. 5 is a waveform diagram describing the operation of the data input unit shown in FIG. 4, showing the test results on whether data are received through the data input circuit after the semiconductor memory device is manufactured.

When a clock signal CLOCK transition occurs, test command TRMS is received. After that, active command ACT, write command WRITE and read command READ, and precharge command PRE are sequentially input. During the test process, only designated data input circuits are used, rather operating all of the 32 data input circuits shown in FIG. 4. Here, data input circuits receive 4 data signals DQ0, DQ2, DQ4 and DQ6 for the test process. This data input test using only a part of the data input circuits is intended to perform the maximally efficient test by considering the time and costs taken during the test. When necessary, data input circuits that receive the data signals DQ0, DQ2, DQ4 and DQ6, and data signals DQ9, DQ11, DQ13 and DQ15 may be used to perform the test operation. The number of test input circuits used during the test may be appropriately set by taking into account the test time and costs.

When the enable signal EN is activated by low level, the data signals DQ0, DQ2, DQ4 and DQ6 are input to the data input circuits. When the enable signal EN is inactivated by high level, the input nodes of the data input circuits maintain high impedance HI-Z for a predetermined time period. During the intervals that the data signals DQ0, DQ2, DQ4 and DQ6 are validly input when the enable signal EN is activated, the data input circuits output internal data signals of high level or low level H/L. During the remaining intervals that the data signals are not validly input at the activation intervals of the enable signal EN, the output nodes of the data input circuits become an empty interval state VOID. Data input circuits, which are not used during the test, that is, data input circuits that receive data signals except the data signals DQ0, DQ2, DQ4 and DQ6 maintain their output nodes at empty intervals VOID under the state the enable signal is activated.

Under the above state, when noise is occurs, there exists a problem that the data input circuits appear to output valid internal data signals during the empty intervals as mentioned above. The used data input circuits may cause the same problems during the test empty intervals. Further, even if the data input circuits do not deliver false validity data due to noise, an internal leakage current can occur, causing unnecessary current consumption.

### SUMMARY OF THE INVENTION

It is, therefore, an object of the present invention to provide a semiconductor memory device which is capable of reducing a leakage current being applied to data input circuits, and also preventing malfunction during a test.

In accordance with one aspect of the present invention, there is provided a semiconductor memory device, including: a first data input circuit for receiving a first data signal; a second data input circuit for taking a second data signal and providing the second data signal as an internal data signal, and which is disabled in response to a test mode signal; and an input controller for controlling input timing of data signals being input to the first and the second data input circuits.

In accordance with another aspect of the present invention, there is provided a semiconductor memory device, including: a plurality of data input circuits for receiving a plurality of data signals, respectively; and an input controller for selectively disabling some of the plurality of data input circuits that are not used in a test mode.

In accordance with a further another aspect of the present invention, there is provided a method for driving a semiconductor memory device, including the steps of: entering a test mode; disabling some of a plurality of data input circuits that do not receive data signals for test in the test mode; entering a normal mode; and enabling all of the plurality of data input circuits in synchronism with a data input timing.

Other objectives and advantages of the invention will be understood by the following description and will also be appreciated by the embodiments of the invention more clearly.

### BRIEF DESCRIPTION OF THE DRAWINGS

FIG. 1 is a block diagram of a conventional data input circuit.

FIG. 2 is a circuit diagram for generating the enable signal used in the data input circuit shown in FIG. 1.

FIG. 3 is a waveform diagram describing the operation of the data input circuit depicted in FIG. 1.

FIG. 4 is a block diagram of a data input unit used in the semiconductor memory device.

FIG. 5 is a waveform diagram describing the operation of the data input unit shown in FIG. 4.

FIG. 6 is a block diagram is a semiconductor memory device in accordance with a preferred embodiment of the present invention.

FIG. 7 is a detailed circuit diagram of the second data input circuit depicted in FIG. 6.

FIG. 8 is a detailed circuit diagram of the input controller shown in FIG. 6.

FIG. 9 is a waveform diagram describing the operation of the semiconductor memory device shown in FIG. 6.

FIG. 10 is a block diagram illustrating a semiconductor memory device in accordance with a preferred second embodiment of the present invention.

FIG. 11 is a detailed circuit diagram of the data input circuit shown in FIG. 10.

FIG. 12 is a detailed circuit diagram of the input controller shown in FIG. 10.

FIG. 13 is a waveform diagram describing the operation of the semiconductor memory device shown in FIG. 10.

### DESCRIPTION OF SPECIFIC EMBODIMENTS

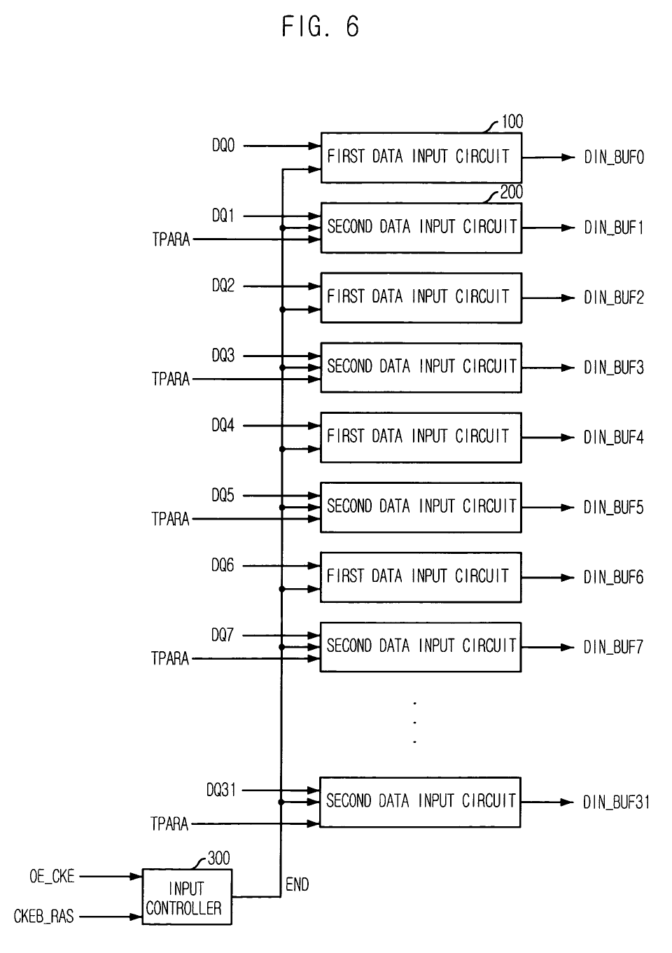

FIG. 6 is a block diagram of a semiconductor memory device in accordance with a preferred embodiment of the present invention.

Referring to FIG. 6, the semiconductor memory device of the present invention includes a first data input circuit 100 for receiving a data signal DQ0 and outputting it as an internal data signal DIN_BUF0, a second data input circuit 200 for receiving a data signal DQ1 and providing it as an internal data signal DIN_BUF1, and which is disabled in response to a test mode signal TPARA, and an input controller 300 for receiving control signals OE_CKE and CKEB_RAS and outputting an input control signal END to control input timing of the data signals DQ0 and DQ1 input to the first and the second data input circuits 100 and 200. The plurality of first data input circuits illustrated in FIG. 6 have the same configurations and the plurality of second input circuits also have the same configurations. Although it is assumed that a 32-bit data signal is input during a single data access and 32 corresponding data input circuits are shown, the number of the data input circuits may be varied appropriately where necessary.

During a normal operation for a data access, the first and the second data input circuits are all operated. During the normal operation, in response to the input control signal END generated by the input controller 300, all the first and the second data input circuits output input data signals DQ0 to DQ31 as internal data signals DIN_BUF0 to DIN_BUF31, respectively.

In a test mode to test whether the semiconductor memory device operates properly, the plurality of second data input circuits are inactivated in response to the test mode signal TPARA. The plurality of first data input circuits receive data signals DQ0, DQ2, DQ4, and DQ6 provided for test and output them as internal data signals DIN_BUF0, DIN_BUF2, DIN_BUF4, and DIN_BUF6. In the test mode, it is assumed that 4 first data input circuits are used. As the data input circuits that must perform the normal operation in the test mode, for example, there are arranged the first data input circuits. Operation of part of the data input circuits, without operating them all , reduces the time and costs of the test mode.

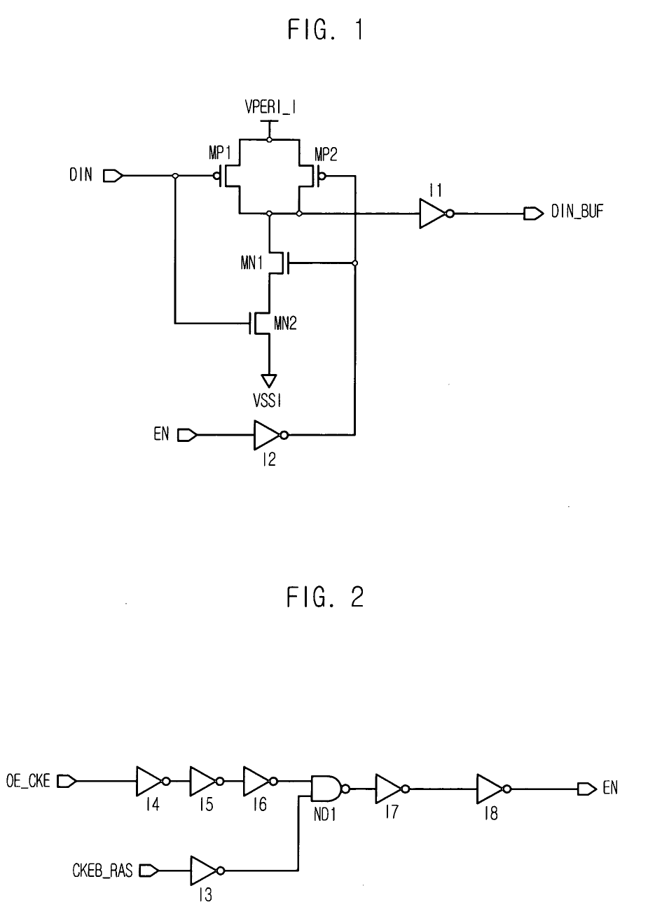

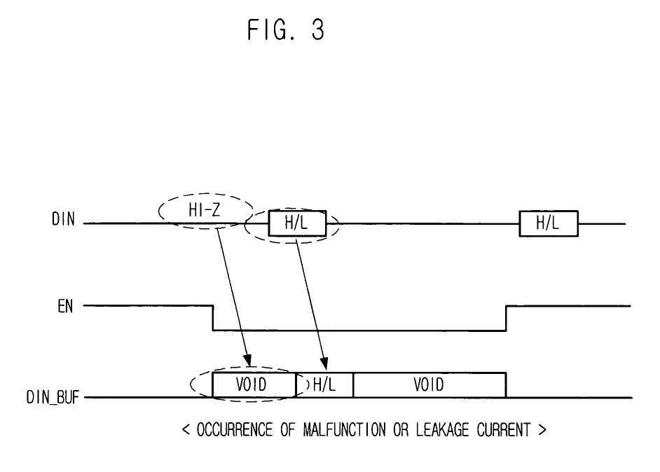

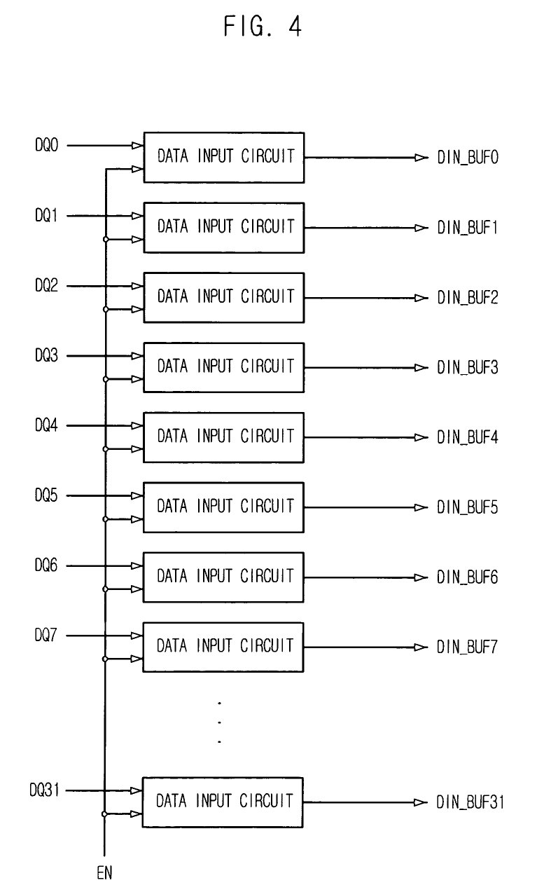

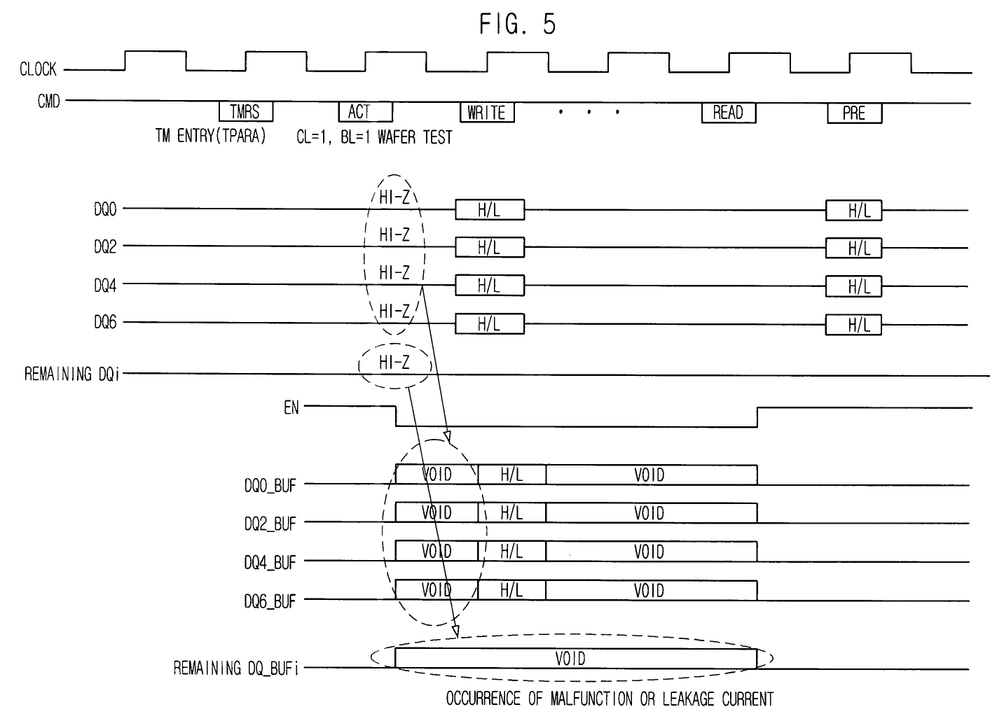

Each of the first data input circuits includes a general data input circuit, and may be configured by using the circuit shown in FIG. 1.

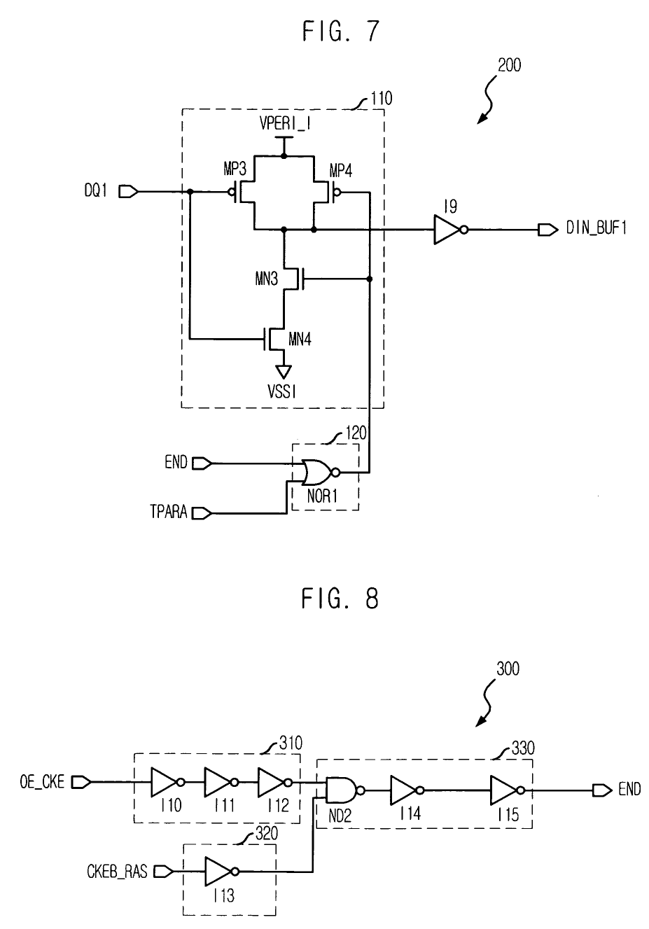

FIG. 7 is a detailed circuit diagram of the second data input circuit 200 depicted in FIG. 6.

Referring to FIG. 7, the second data input circuit 200 comprises a data signal buffering unit 110 that is activated in response to an enable signal E for buffering the second data signal DQ1, and an enable signal generator 120 for generating the enable signal E in response to the input control signal END from the input controller 300 and the test mode signal TPARA. In addition, the second data input circuit 200 includes an inverter I9 for inverting an output signal from the data signal buffering unit 110 and applied as the internal data signal DIN_BUF1.

The data signal buffering unit 110 is composed of an NAND gate for receiving the second data signal DQ1 via one input end and the enable signal E via the other input end. The enable signal generator 120 is composed of a NOR gate NOR1 for receiving the test mode signal PTARA and the input control signal END and outputting the enable signal E.

In the normal mode, the second data input circuit 200 receives the data signal DQ1 and outputs it as the internal data signal DIN_BUF1 in response to the input control signal END activated to low level, as in the first data input circuit. At this time, the test mode signal TPARA is maintained as low level, and thus, the enable signal generator 120 activates the enable signal E to high level and then outputs it.

In the test mode, since the test mode signal TPARA is input as high level although the input control signal END is activated to low level and then input, the enable signal generator 120 inactivates the enable signal E to low level and then outputs it. Accordingly, the second data input circuit 200 outputs the internal data signal DIN_BUF1 of low level regardless of the state of the input data signal DQ1. In the test mode, the second data input circuit, as configured in FIG. 7, does not receive data signal for test and is not operated. However, when the signal level of the data signal DQ1 is affected by noise, the internal data signal DIN_BUF1 may be erroneously output. In the test mode, since the enable signal E is maintained in the inactivation state due to the test mode signal TPARA, the internal data signal DIN_BUF1 can be maintained in the stable state of low level.

FIG. 8 is a detailed circuit diagram of the input controller shown in FIG. 6.

With reference to FIG. 8, the input controller 300 comprises a first buffer 310 for receiving and buffering a first control signal, a second buffer 320 for receiving and buffering a second control signal, and a logic circuit 330 for logically multiplying the outputs from the first and the second buffers 310 and 320 to generate the input control signal END. This input controller 300 generates the input control signal END activated to low level by combining the logic levels of the control signals OE_CKE and CKEB_RAS.

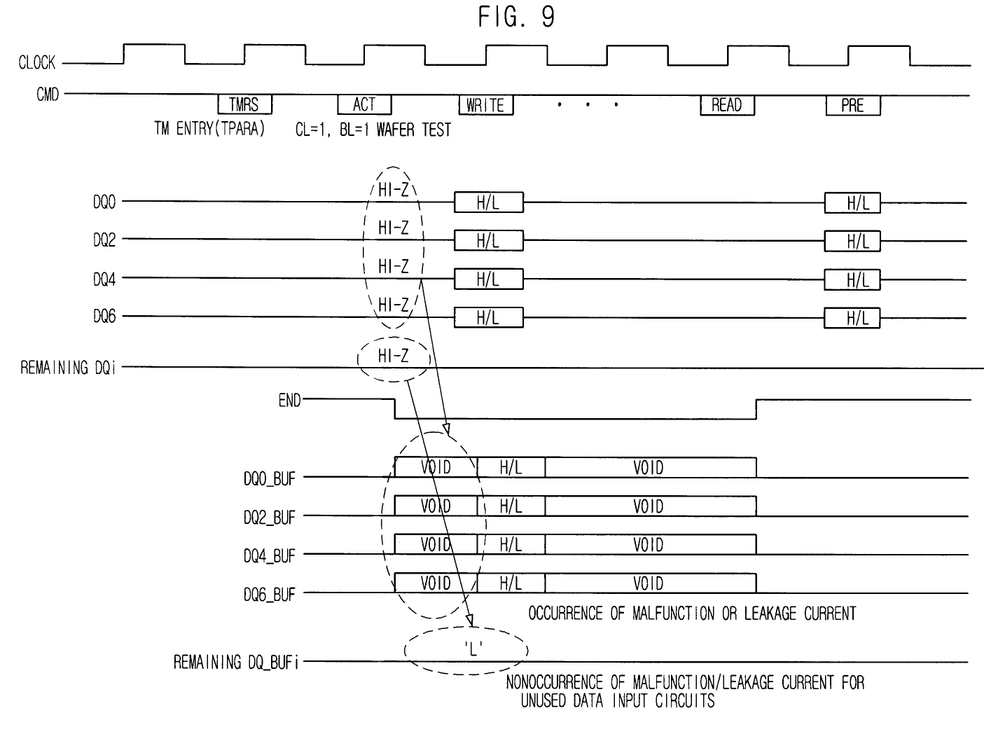

FIG. 9 is a waveform diagram describing the operation of the semiconductor memory device shown in FIG. 6.

As illustrated therein, when a clock signal CLOCK transition occurs, test command TRMS is input. After that, active command ACT, write command WRITE and read command READ, and precharge command PRE are input. During the test process, only designated data input circuits are operated, rather than making all of the 32 data input circuits as shown in FIG. 6 operated. Here, only data input circuits that receive 4 data signals DQ0, DQ2, DQ4 and DQ6 are used to perform the test. As discussed above, this data input test using a part of the data input circuits is to perform the maximally efficient test by considering the time and costs taken during the test. The number of data input circuits used during the test may be determined appropriately by taking account into the test time and costs.

Since the test mode signal TPARA is input as high level, the second data input circuits maintain all the internal data signals to be output as low levels. The first data input circuits are activated by the input control signal END to receive the data signals DQ0, DQ2, DQ4 and DQ6 and output them as the internal data signals DQ0_BUF, DQ2_BUF, DQ4_BUF and DQ6_BUF. When the enable signal EN is activated, while the data signals DQ0, DQ2, DQ4 and DQ6 are validly input, the plurality of first data input circuits output the internal data signals of high level or low level H/L. Further, during the remaining intervals that the data signals are not validly received at the activation intervals of the enable signal EN, the output nodes of the data input circuits become an empty interval state VOID.

As set forth above, since the data input circuits, which are not used in the test mode, maintain their output ends as low levels, and therefore, no malfunction is caused by the unused data input circuits or no leakage current is occurred.

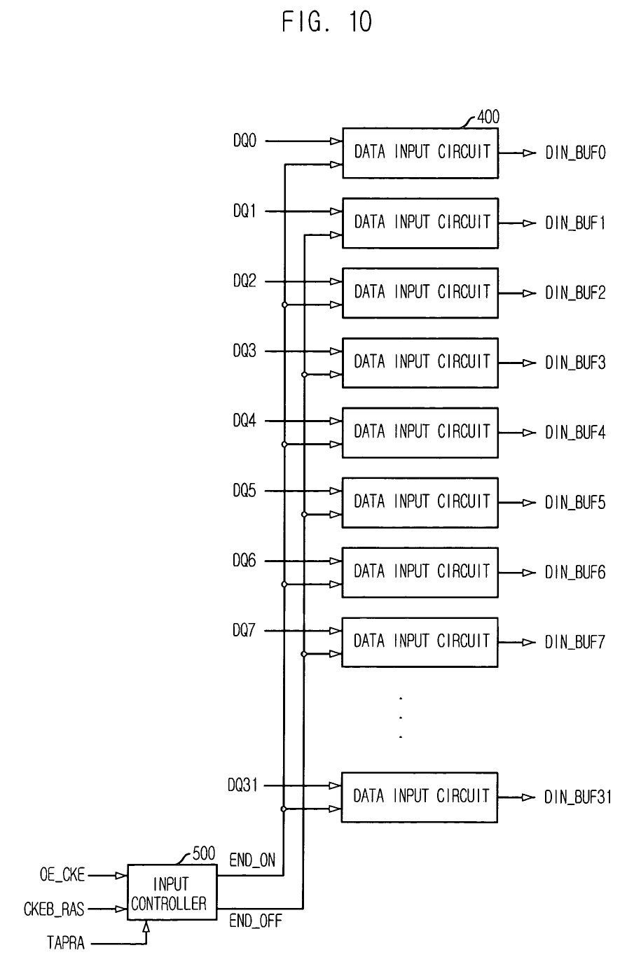

FIG. 10 is a block diagram illustrating a semiconductor memory device in accordance with a preferred second embodiment of the present invention.

Referring to FIG. 10, the semiconductor memory device according to this embodiment includes a plurality of data input circuits for receiving a plurality of data signals, respectively, and an input controller 500 for selectively disabling some of the plurality of data input circuits that are not used in a test mode.

In the semiconductor memory device according to this embodiment, the data input circuits provided therein are all operated in the normal mode. Each data input circuit outputs receives an input data signal and outputs it as an internal data signal DIN_BUF0. The input controller 500 accepts control signals OE_CKE and CKEB_RAS and a test mode signal TPARA, and outputs input control signals END_ON and END_OFF for selectively enabling the data input circuits. These data input circuits all have the same configurations, but receive different signals provided from the input controller 500. The input circuits used in the test mode receive the input control signal END_ON, whereas the input circuits not used in the test mode receive the control signal END_OFF. Therefore, the data input circuits receive one of the input control signals END_ON and END_OFF that is selected depending on whether they are used in the test mode. In this embodiment, the data input circuits receiving the first input control signal END_ON and the data input circuits receiving the second input control signal END_OFF are arranged in turn. The data input circuits receiving the first input control signal END_ON are all operated in both the normal mode and the test mode, and output the input data signals as the internal data signals. The data input circuits accepting the second input control signal END_OFF provide the input data signals as the internal data signals in the normal mode, but are not operated in the test mode.

FIG. 11 is a detailed circuit diagram of the data input circuit 400 shown in FIG. 10.

Referring to FIG. 11, the data input circuit 400 is composed of an NAND gate that receives a data signal DQ0 via one input terminal and an inverted first input control signal END_ON via the other input terminal. In addition, the data signal input circuit 400 includes an inverter for inverting an output from the NAND gate to produce an internal data signal DIN_BUF0. There is provided the data input circuit receiving the first input control signal END_ON. Also, the data input circuit receiving the second input control signal END_OFF may have the same configuration as that shown in FIG. 11. One difference is that the data input circuit receiving the second input control signal END_OFF does not use the inverter I2, while the data input circuit receiving the first input control signal END_ON uses it.

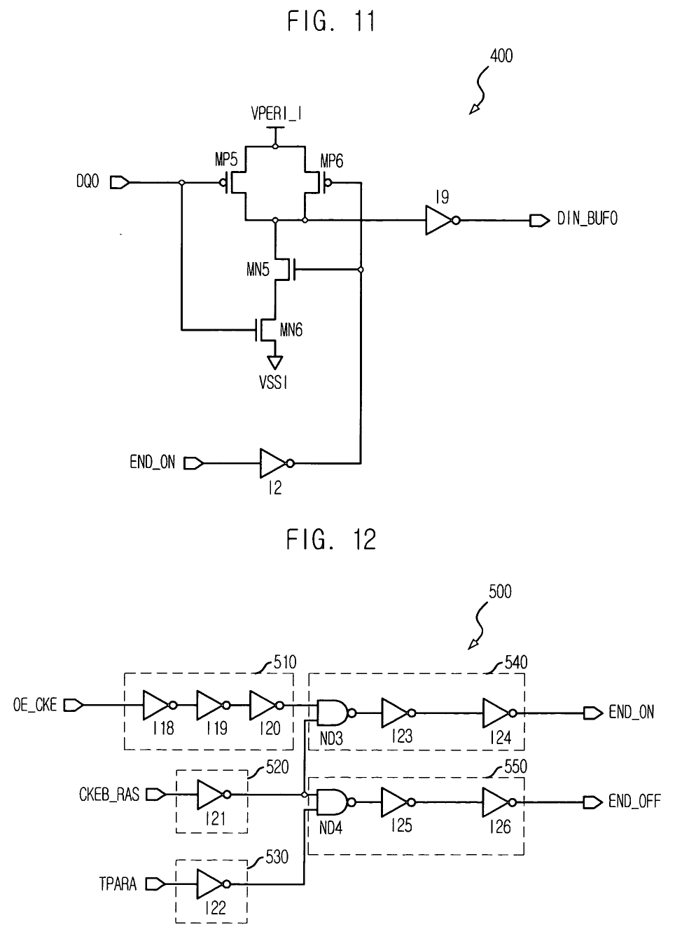

FIG. 12 is a detailed circuit diagram of the input controller shown in FIG. 10.

Referring to FIG. 12, the input controller 500 outputs the first and the second input control signals END_ON and END_OFF in response to the first and the second control signals OE_CKE and CKEB_RAS, wherein the second input control signal END_OFF is inactivated and output in response to the test mode signal TPARA that is activated and received in the test mode.

More specifically, the input controller 500 comprises a first buffer 510 for receiving and buffering the first control signal OE_CKE, a second buffer 520 for receiving and buffering the second control signal CKEB_RAS, a third buffer 530 for buffering the test signal TPARA activated in the test mode, a first logic circuit 540 for logically multiplying the outputs from the first and the second buffers 510 and 520 to generate the first input control signal END_ON, and a second logic circuit 550 for logically multiplying the outputs from the second and the third buffers 520 and 530 to generate the second input control signal END_OFF.

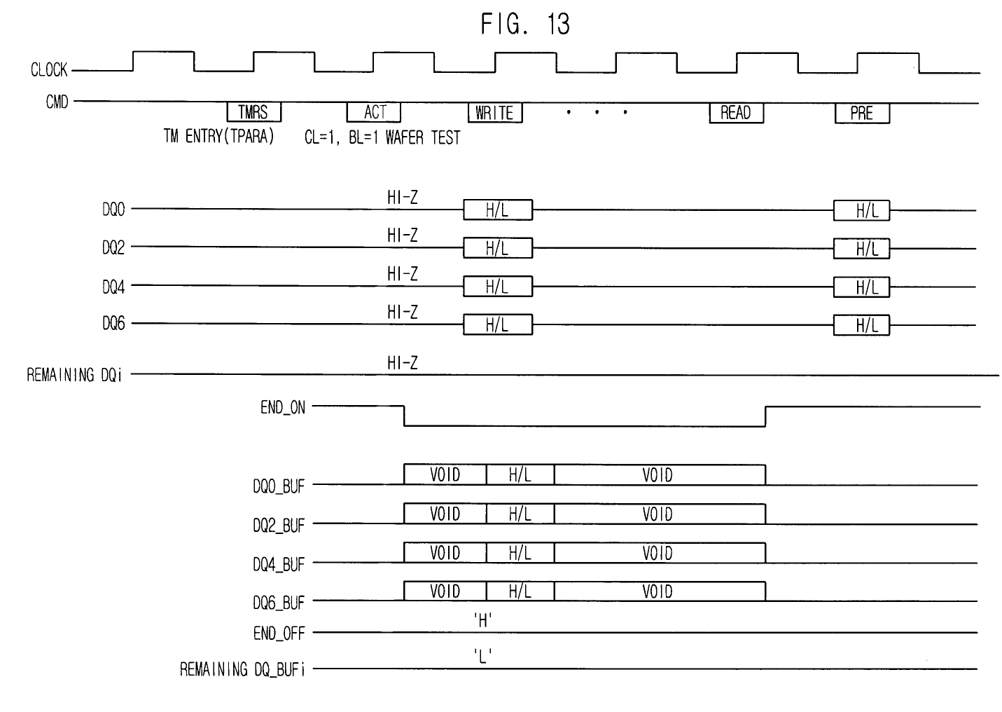

FIG. 13 is a waveform diagram describing the operation of the semiconductor memory device shown in FIG. 10.

As illustrated therein, when a clock signal CLOCK is transited, test command TRMS is input. Thereafter, active command ACT, write command WRITE and read command READ, and recharge command PRE are sequentially input. During the test process, only designated data input circuits are used, rather than making all of the 32 data input circuits as shown in FIG. 10 operated. Here, only data input circuits that receive 16 data signals DQ0, DQ2, DQ4, DQ6, . . . , DQ30 are used to perform the test.

In the test mode, since the test mode signal TPARA is input as high level, the second input control signal END_OFF is output from the input controller 500 as high level. Thus, the data input circuits receiving the second input control signal END_OFF are all in a disable state. Specifically, the second data input circuits receiving the second input control signal END_OFF all maintain the internal data signals to be output as low levels. The data input circuits receiving the first input control signal END_ON are activated even in the test mode, and receive the data signals and output them as the internal data signals. Accordingly, since all of the data input circuits that are not used in the test mode maintain their output ends as low levels, no malfunction is caused by the unused data input circuits or no leakage current is occurred.

As a result, when a large number of data input circuits employed, a reliable test can be stably performed although only a part of the data input circuits is used for the test. In particular, even though a signal similar to a data signal is input to the data input circuits that do not receive the data signal due to noise during the test, those data input circuits are not operated, thus preventing malfunctioning during the test. Moreover, leakage current of the data input circuits that receive data signals can be remarkably reduced.

While the present invention has been described with respect to the specific embodiments, it will be apparent to those skilled in the art that various changes and modifications may be made without departing from the spirit and scope of the invention as defined in the following claims.

What is claimed is:

1. A semiconductor memory device, comprising:
a first data input circuit for receiving a first data signal;
a second data input circuit for receiving a second data signal, and which is disabled in response to a test mode signal; and
an input controller for controlling input timing of data signals being input to the first and the second data input circuits.

2. The semiconductor memory device as recited in claim 1, wherein the first data input circuit comprises an NAND gate for receiving the first data signal via one input terminal and an input control signal provided from the input controller via the other input terminal.

3. The semiconductor memory device as recited in claim 1, wherein the second data input circuit includes:
an enable signal generator for generating an enable signal in response to an input control signal provided from the input controller and the test mode signal; and
a data signal buffering unit, activated in response to the enable signal, for providing the second data signal as the internal data signal.

4. The semiconductor memory device as recited in claim 3, wherein the enable signal generator comprises a NOR gate for receiving the test mode signal and the input control signal and outputting the enable signal.

5. The semiconductor memory device as recited in claim 4, wherein the data signal buffering unit comprises a NAND gate for receiving the second data signal via one input terminal and the enable signal via the other input terminal.

6. The semiconductor memory device as recited in claim 5, wherein the second data input circuit further includes an inverter for inverting the internal data signal output from the data signal buffer to provide an inverted data signal.

7. The semiconductor memory device as recited in claim 6, wherein the input controller includes:
a first buffer for buffering a first control signal;
a second buffer for buffering a second control signal; and
a logic circuit for logically multiplying the outputs from the first and the second buffers to generate the input control signal.

8. A semiconductor memory device, comprising:
a plurality of data input circuits for receiving a plurality of data signals, respectively; and
an input controller for selectively disabling some of the plurality of data input circuits that are not used in a test mode.

9. The semiconductor memory device as recited in claim 8, wherein the input controller outputs first and second input control signals in response to first and second control signals, the second input control signal inactivated during the test mode, and
the plurality of data input circuits are activated in response a selected one of the first and the second input control signals.

10. The semiconductor memory device as recited in claim 9, wherein the plurality of data input circuits are arranged in a manner that the data input circuits receiving the first input control signal and the data input circuits receiving the second input control signal are alternately arranged.

11. The semiconductor memory device as recited in claim 10, wherein each of the data input circuits comprises a NAND gate for receiving the corresponding data signal via a first input terminal and a selected one selected of the first and the second control signals via a second input terminal.

12. The semiconductor memory device as recited in claim 11, wherein the data input circuit further includes an inverter for inverting the signal output from the NAND gate to provide an inverted signal.

13. The semiconductor memory device as recited in claim 12, wherein the input controller includes:
a first buffer for buffering a first control signal;
a second buffer for buffering a second control signal;
a third buffer for buffering a test signal activated in the test mode;
a first logic circuit for logically multiplying the outputs from the first and the second buffers to generate the first input control signal; and
a second logic circuit for logically multiplying the outputs from the second and the third buffers to generate the second input control signal.

14. A method for driving a semiconductor memory device, comprising the steps of:
entering a test mode;
disabling some of a plurality of data input circuits that do not receive data signals for test in the test mode;
entering a normal mode; and
enabling all of the plurality of data input circuits in synchronism with a data input timing.

15. The method as recited in claim 14, wherein the disabling step comprises setting outputs of the plurality of data input circuits that do not receive data signals for test in the test mode to a predetermined logic level.
